(19) United States
(12) Patent Application Publication
(10) Pub. No.: US 2026/0358515 A1
(43) Pub. Date: Nov. 12, 2026

(54) Radiometric Measuring Apparatus for Measuring a Measurement Variable of a Substance, System Comprising a Radiometric Measuring Apparatus, and Method for Measuring a Measurement Variable of a Substance by Means of a Radiometric Measuring Apparatus and/or a System

(71) Applicant: BERTHOLD TECHNOLOGIES GmbH & Co. KG, Bad Wildbad (DE)

(72) Inventor: Lukas KUDER, Bad Wildbad (DE)

(21) Appl. No.: 19/671,360

(22) Filed: May 8, 2026

(30) Foreign Application Priority Data
May 9, 2025 (DE) 102025117906.9

(51) Int. Cl. G01T 1/208

(52) U.S. Cl. CPC G01T 1/208

(57) ABSTRACT

A radiometric measuring apparatus for measuring a measurement variable of a substance is provided. The radiometric measuring apparatus includes a photomultiplier having a photocathode, a plurality of dynodes and an anode, a control device which is designed to tap off a control signal at a tapping dynode of the dynodes and to control a high voltage applied from the photocathode via the dynodes to the anode as a function of the control signal tapped off, and a measuring device which is designed to tap off a measurement signal at the anode with the controlled high voltage applied and to measure the measurement variable as a function of the measurement signal tapped off.

### CROSS REFERENCE TO RELATED APPLICATION

This application claims priority under 35 U.S.C. §119 from German Patent Application No. 10 2025 117 906.9, filed May 9, 2025, the entire disclosure of which is herein expressly incorporated by reference.

### FIELD OF APPLICATION

The invention relates to a radiometric measuring apparatus for measuring a measurement variable of a substance, to a system comprising such a radiometric measuring apparatus, and to a method for measuring a measurement variable of a substance by means of such a radiometric measuring apparatus and/or such a system.

### OBJECT AND ACHIEVEMENT

The invention is based on the object of providing a radiometric measuring apparatus for measuring a measurement variable of a substance, a system comprising such a radiometric measuring apparatus, and a method for measuring a measurement variable of a substance by means of such a radiometric measuring apparatus and/or such a system, which has, in particular in each case, improved properties.

The invention achieves this object by providing a radiometric measuring apparatus and a method described in the independent claims. Advantageous developments of the invention are described in the dependent claims.

The radiometric measuring apparatus according to the invention is designed in particular to measure a measurement variable of a substance. The measuring apparatus has a photomultiplier (“PMT”, abbreviation of “photomultiplier tube”), a control device and a measuring device. The photomultiplier has a photocathode, a plurality of dynodes and an anode. The control device is designed to tap off a control signal at, in particular precisely, one tapping dynode of the dynodes. The control device is designed to control a high voltage applied from the photocathode via the dynodes to the anode as a function of, in particular precisely, the control signal tapped off. The measuring device is designed to tap off a measurement signal at, in particular precisely, the anode with the controlled high voltage applied or at the controlled high voltage. The measuring device is designed to measure the measurement variable as a function of, in particular precisely, the measurement signal tapped off.

This makes it possible for the control signal in the photomultiplier to be amplified more weakly than or not as strongly as or not fully compared to the measurement signal in the photomultiplier. Thus, if the control signal is caused by control radiation, the measurement signal is caused by measurement radiation, and the control radiation has a higher energy than the measurement radiation, this makes it possible for the control signal in the photomultiplier to be only linearly amplified and/or to be free of a saturation effect, and in particular for the measurement signal in the photomultiplier to be only linearly amplified and/or to be free of a saturation effect. This thus enables good, in particular correct, control of the high voltage, for example in order to be independent of a temperature of the measuring apparatus and/or of its parts or its components. This thus enables good, in particular correct, amplification of the measurement signal in the photomultiplier. This thus enables good, in particular correct, measurement of the measurement variable.

In particular, the term component "device", "detector" or "sensor" can be used synonymously for the term component "apparatus".

The term "record" may be used synonymously for the term "measure".

The measurement, the tapping-off and/or the control can be implemented automatically and/or in a computer-implemented manner, in particular by means of a computing device and/or a memory device and/or a computer of the measuring apparatus.

The term "useful variable" may be used synonymously for the term "measurement variable".

The measurement variable, the control signal, the high voltage and/or the measurement signal can have a value and/or be physical.

The term "measurement material" or "measurement medium" can be used synonymously for the term "substance".

The term "configured", "set up" or "provided" or the phrase "programmed to perform the function(s) of" may be used synonymously for the term "designed".

The term "comprises" or "has" can be used synonymously for the term "includes".

The photomultiplier, the control device and/or the measuring device can be different.

The term "separate" or "isolated" may be used synonymously for the term "different".

The dynodes can be cascaded.

The control device and/or the measuring device can be electrical, in particular electronic.

The phrase "first device" can be used synonymously for the term "control device" and the phrase "second device" can be used synonymously for the term "measuring device".

The term (component) "monitoring" or "adaptation" can be used synonymously for the term (component) "control".

The term "pick off" may be used synonymously for the term "tap off".

The term component "pulse" or "voltage" can be used synonymously for the term component "signal".

The phrase "first signal" can be used synonymously for the term "control signal" and the phrase "second signal" can be used synonymously for the term "measurement signal".

The control signal and the measurement signal can be different.

The control signal, the high voltage and/or the measurement signal can be electrical.

The control signal may be tapped off at a first dynode output of the tapping dynode and/or not at the anode.

The high voltage can be adjustable or variable, can be an amplifier high voltage and/or can be for amplifying or determining the amplification of the control signal and of the measurement signal.

The high voltage cannot be controlled as a function of the measurement signal tapped off.

The phrase "based on" or "on the basis of" may be used synonymously for the phrase "as a function of".

The term "determine" or "calculate" may be used synonymously for the term "measure".

The measurement signal cannot be tapped off at one of the dynodes.

The measurement variable cannot be measured as a function of the control signal tapped off.

The term "only" may be used synonymously for the term "precisely".

Furthermore, reference is made to the technical literature.

In one development of the invention, the control signal is caused by, in particular precisely, the control radiation in the form of the cosmic radiation. In particular, the control radiation has not penetrated the substance. This, in particular the long-term constancy of the intensity of the cosmic radiation, enables particularly good control of the high voltage. In particular, the control radiation can be high-energy, from the upper atmosphere or the earth’s outer atmosphere, and/or gamma radiation. Additionally or alternatively, the phrase "first radiation" can be used synonymously for the term "control radiation". Furthermore, additionally or alternatively, the term "converted" can be used synonymously for the term "caused". Furthermore, additionally or alternatively, the phrase "not interacted with the substance" can be used synonymously for the phrase "not penetrated the substance".

In one development of the invention, the measurement signal is caused by, in particular precisely, the measurement radiation emitted by a Co-60, Cs-137, Eu-152, Am-241 and/or Cm-244 measurement radiation source. In particular, the measurement radiation has at least partially, in particular completely, penetrated the substance. This permits particularly good measurement of the measurement variable. In particular, the measurement radiation can be low-energy and/or gamma radiation. Additionally or alternatively, the phrase "second radiation" can be used synonymously for the term "measurement radiation". Furthermore, additionally or alternatively: Co-60 is an abbreviation of cobalt-60, Cs-137 is an abbreviation of cesium-137, Eu-152 is an abbreviation of europium-152, Am-241 is an abbreviation of americium-241 and Cm-244 is an abbreviation of curium-244. Furthermore, additionally or alternatively, the phrase "interacted with the substance" can be used synonymously for the phrase "penetrated the substance".

In one development of the invention, the control signal is caused by the radiometric, in particular ionizing, control radiation. In particular, the control radiation has not penetrated the substance. The measurement signal is caused by the radiometric, in particular ionizing, measurement radiation. In particular, the measurement radiation has at least partially penetrated the substance. The control radiation has higher energy than the measurement radiation. This is made possible by tapping off the control signal at the tapping dynode upstream of the anode. In particular, the control signal cannot be caused by the measurement radiation. Additionally or alternatively, the measurement signal cannot be caused by the control radiation. Furthermore, additionally or alternatively, the control radiation and the measurement radiation can be different, in particular emitted by different radiation sources. Furthermore, additionally or alternatively, the term "large" can be used synonymously for the term "high".

In one development of the invention, the control device is designed to control the high voltage to be so low or to such a low value that the tapped-off control signal in the photomultiplier is linearly amplified, and in particular the tapped-off measurement signal in the photomultiplier is linearly amplified. This is made possible by tapping off the control signal at the tapping dynode upstream of the anode. In particular, the term "small" can be used synonymously for the term "low". Additionally or alternatively, the term "proportional" can be used synonymously for the term "linear". Furthermore, additionally or alternatively, the high voltage can be lower than a saturation threshold or limit value.

In one development of the invention, the photomultiplier, in particular from the photocathode via the dynodes to the anode, has a, in particular linear, gain over a dynamic range having a value of at most 10⁶ radiation events per second, in particular at most 10⁵ radiation events per second, and in particular at least 10⁰ radiation events per second, in particular at least 10¹ radiation events per second. This enables particularly good control of the high voltage, particularly good amplification of the measurement signal in the photomultiplier and/or particularly good measurement of the measurement variable. In particular, the term "dynamic response" can be used synonymously for the term "dynamic range". Additionally or alternatively, the term "factor" can be used synonymously for the term "value". Furthermore, additionally or alternatively, the term "impulse", “pulse” or “gamma photon” can be used synonymously for the term "radiation event".

In one development of the invention, a, in particular linear, gain from the tapping dynode to the anode has a value of at least 1.5, in particular at least 3, and/or at most 1000, in particular at most 100, in particular 10. This allows the control radiation to have higher energy than the measurement radiation, particularly good amplification of the measurement signal in the photomultiplier and/or particularly good measurement of the measurement variable.

In one development of the invention, the tapping dynode is close to the anode from one half, in particular one quarter, of the dynodes. This allows the control signal to be tapped off at one of the rear or last dynodes.

In one development of the invention, the control device has capacitive control output coupling for tapping off the control signal at the tapping dynode. The measuring device has capacitive measurement output coupling for tapping off the measurement signal at the anode. The measurement output coupling is different from the control output coupling, in particular completely. In particular, the phrase "first output coupling" can be used synonymously for the term "control output coupling" and the phrase "second output coupling" can be used synonymously for the term "measurement output coupling". Additionally or alternatively, the output coupling can be signal output coupling. Furthermore, additionally or alternatively, the control output coupling can be electrically connected to the tapping dynode, in particular directly. Furthermore, additionally or alternatively, the measurement output coupling can be electrically connected to the anode, in particular directly. In particular, the term "immediately" can be used synonymously for the term "directly". Furthermore, additionally or alternatively, the measurement output coupling may not be different from the control output coupling, or the measurement output coupling can be structurally identical to or of the same design as the control output coupling. Furthermore, additionally or alternatively, the control output coupling may be a control capacitor. Furthermore, additionally or alternatively, the measurement output coupling may be a measurement capacitor.

In one development of the invention, the control device has a control evaluation device. The control evaluation device is designed to evaluate the tapped-off control signal for controlling the high voltage. In particular, the control evaluation device has a control amplifier. The control amplifier is designed to amplify the tapped-off control signal. The measuring device has a measurement evaluation device. The measurement evaluation device is designed to evaluate the tapped-off measurement signal for measuring the measurement variable. In particular, the measurement evaluation device has a measurement amplifier. The measurement amplifier is designed to amplify the tapped-off measurement signal. The measurement evaluation device is at least partially different from the control evaluation device. In particular, the control evaluation device and/or the measurement evaluation device can be electrical, in particular electronic. Additionally or alternatively, the evaluation and/or the amplification can be automatic, computer-implemented and/or take into account the tapping-off of the control signal at the tapping dynode upstream of the anode. Furthermore, additionally or alternatively, the phrase "first evaluation device" can be used synonymously for the term "control evaluation device" and the phrase "second evaluation device" can be used synonymously for the term "measurement evaluation device". Furthermore, additionally or alternatively, the evaluation device may be a signal evaluation device. Furthermore, additionally or alternatively, the phrase "first amplifier" can be used synonymously for the term "control amplifier" and the phrase "second amplifier" can be used synonymously for the term "measurement amplifier". Furthermore, additionally or alternatively, the control amplifier can be electrically connected to the control output coupling, in particular directly. Furthermore, additionally or alternatively, the measurement amplifier can be electrically connected to the measurement output coupling, in particular directly. Furthermore, additionally or alternatively, the measurement amplifier can be different from the control amplifier, in particular completely. Furthermore, additionally or alternatively, the measurement amplifier may not be different from the control amplifier, or the measurement amplifier can be structurally identical to or of the same design as the control amplifier. Furthermore, reference is made to the technical literature.

In one development of the invention, the measuring apparatus has a high-voltage source. The high-voltage source is designed to apply the high voltage. In particular, the high-voltage source can be electrical, in particular electronic. Additionally or alternatively, the application may be automatic and/or computer-implemented. Furthermore, additionally or alternatively, the high-voltage source can be electrically connected to the photocathode, the dynodes and the anode, in particular indirectly or mediately, in particular by means of a voltage divider or a voltage divider chain. Furthermore, additionally or alternatively, the high-voltage source can be electrically connected to the control device, in particular directly.

In one development of the invention, the measuring apparatus has a scintillator. The scintillator is designed to convert radiometric, in particular ionizing, radiation, in particular the control radiation and the measurement radiation in each case, into photon signals for or onto the photocathode, in particular in order to cause the control signal and the measurement signal in each case. In particular, the measuring apparatus has a rod and/or solid-state scintillator. In particular, the conversion may be automatic. Additionally or alternatively, the photon signals may be light photons.

In one development of the invention, the measurement variable is representative of a fill level and/or a limit level of the substance arranged within a hollow body and/or a density and/or a concentration of the substance. In particular, the term "characteristic" can be used synonymously for the term "representative". Additionally or alternatively, the measurement variable may be the fill level, the limit level, the density and/or the concentration. Furthermore, additionally or alternatively, the term "container" or “tank” can be used synonymously for the term "hollow body".

The system according to the invention comprises the radiometric measuring apparatus as mentioned above. In addition, the system comprises the measurement radiation source and/or the hollow body. The measurement radiation source is designed to emit the measurement radiation to cause the measurement signal. The hollow body is designed to arrange the substance within it. In particular, the emission can be automatic and/or computer-implemented.

The method according to the invention is for measuring the measurement variable of the substance by means of the radiometric measuring apparatus and/or the system as mentioned above. The method comprises the steps of:
a) tapping off the control signal at the tapping dynode and controlling the high voltage applied from the photocathode via the dynodes to the anode as a function of the tapped-off control signal by means of the control device, and
b) tapping off the measurement signal at the anode with the controlled high voltage applied and measuring the measurement variable as a function of the tapped-off measurement signal by means of the measuring device.

The method may enable the same advantage(s) as mentioned above for the measuring apparatus and/or the system.

In particular, the method can be automatic and/or computer-implemented.

Step b) can be performed simultaneously with or at the same time as and/or temporally after step a).

The method can be performed, in particular multiple times, repeatedly, in particular permanently or continuously or continually over time.

The term "take place" or the phrase "be carried out" or "be implemented" may be used synonymously for the phrase "be performed".

Other objects, advantages and novel features of the present invention will become apparent from the following detailed description of one or more preferred embodiments when considered in conjunction with the accompanying drawings.

### BRIEF DESCRIPTION OF THE DRAWING

Further advantages and aspects of the invention are evident from the claims and from the description of exemplary embodiments of the invention which are explained below with reference to the figure.

FIG. 1 schematically shows a system according to the invention comprising a radiometric measuring apparatus according to the invention for measuring a measurement variable of a substance and a method according to the invention for measuring the measurement variable of the substance by means of the radiometric measuring apparatus and/or the system.

### DETAILED DESCRIPTION OF THE EXEMPLARY EMBODIMENTS

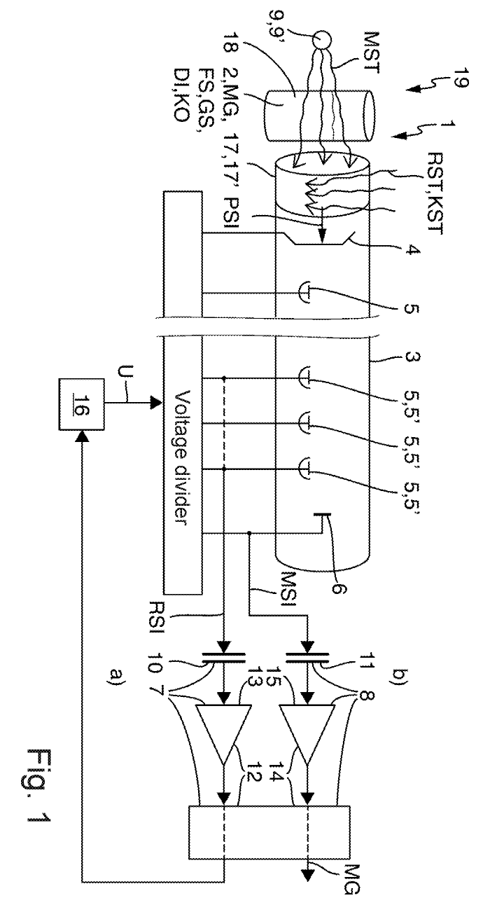

FIG. 1 shows a system 19 according to the invention comprising a radiometric measuring apparatus 1 according to the invention for measuring a measurement variable MG of a substance 2 and a method according to the invention for measuring the measurement variable MG of the substance 2 by means of the radiometric measuring apparatus 1 and/or the system 19.

The measuring apparatus 1 has a photomultiplier 3, a control device 7 and a measuring device 8. The photomultiplier 3 has a photocathode 4, a plurality of dynodes 5 and an anode 6. The control device 7 is designed to tap off, in particular taps off, a control signal RSI at a tapping dynode 5' of the dynodes 5. The control device 7 is designed to control, in particular controls, a high voltage U applied from the photocathode 4 via the dynodes 5 to the anode 6 as a function of the control signal RSI tapped off. The measuring device 8 is designed to tap off, in particular taps off, a measurement signal MSI at the anode 6 with the controlled high voltage U applied. The measuring device 8 is designed to measure, in particular measures, the measurement variable MG as a function of the measurement signal MSI tapped off.

The method comprises the steps of:
a) tapping off the control signal RSI at the tapping dynode 5' and controlling the high voltage U applied from the photocathode 4 via the dynodes 5 to the anode 6 as a function of the tapped-off control signal RSI by means of the control device 7, and
b) tapping off the measurement signal MSI at the anode 6 with the controlled high voltage U applied and measuring the measurement variable MG as a function of the tapped-off measurement signal MSI by means of the measuring device 8.

In the exemplary embodiment shown, the photomultiplier 3 has four dynodes 5. In alternative exemplary embodiments, the photomultiplier can have fewer or more than four dynodes.

In detail, the control signal RSI is caused by control radiation RST in the form of the cosmic radiation KST. In particular, the control radiation RST has not penetrated the substance 2.

Furthermore, the measurement signal MSI is caused by measurement radiation MST emitted by a Co-60, Cs-137, Eu-152, Am-241 and/or Cm-244 measurement radiation source 9’. In particular, the measurement radiation MST has at least partially penetrated the substance 2.

In addition, the control signal RSI is caused by the radiometric, in particular ionizing, control radiation RST. In particular, the control radiation RST has not penetrated the substance 2. The measurement signal MSI is caused by the radiometric, in particular ionizing, measurement radiation MST. In particular, the measurement radiation MST has at least partially penetrated the substance 2. The control radiation RST has higher energy than the measurement radiation MST.

Furthermore, the control device 7 is designed to control, in particular controls, the high voltage U to be so low that the tapped-off control signal RSI in the photomultiplier 3 is linearly amplified, and in particular the tapped-off measurement signal MSI in the photomultiplier 3 is linearly amplified.

Moreover, the photomultiplier 3, in particular from the photocathode 4 via the dynodes 5 to the anode 6, has a, in particular linear, gain over a dynamic range having a value of at most 10⁶radiation events per second, in particular at most 10⁵radiation events per second, and in particular at least 10⁰radiation events per second, in particular at least 10¹radiation events per second.

Furthermore, a, in particular linear, gain from the tapping dynode 5' to the anode 6 has a value of at least 1.5, in particular at least 3, and/or at most 1000, in particular at most 100.

In addition, the tapping dynode 5' is close to the anode 6 from one half, in particular one quarter, of the dynodes 5. In particular, tapping dynode 5' is a rearmost or last of the dynodes 5.

Furthermore, the control device 7 has capacitive control output coupling 10 for tapping off the control signal RSI at the tapping dynode 5'. The measuring device 8 has capacitive measurement output coupling 11 for tapping off the measurement signal MSI at the anode 6. The measurement output coupling 11 is different from the control output coupling 10.

In addition, the control device 7 has a control evaluation device 12. The control evaluation device 12 is designed to evaluate, in particular evaluates, the tapped-off control signal RSI for controlling the high voltage U. In particular, the control evaluation device 12 has a control amplifier 13. The control amplifier 13 is designed to amplify, in particular amplifies, the tapped-off control signal RSI. The measuring device 8 has a measurement evaluation device 14. The measurement evaluation device 14 is designed to evaluate, in particular evaluates, the tapped-off measurement signal MSI for measuring the measurement variable MG. In particular, the measurement evaluation device 14 has a measurement amplifier 15. The measurement amplifier 15 is designed to amplify, in particular amplifies, the tapped-off measurement signal MSI. The measurement evaluation device 14 is at least partially different from the control evaluation device 12.

Furthermore, the measuring apparatus 1 has a high-voltage source 16. The high-voltage source 16 is designed to apply, in particular applies, the high voltage U.

In addition, the measuring apparatus 1 has a scintillator 17. The scintillator 17 is designed to convert, in particular converts, radiometric, in particular ionizing, radiation ST into photon signals PSI for the photocathode 4. In particular, the measuring apparatus 1 has a rod and/or solid-state scintillator 17'.

Furthermore, the measurement variable MG is representative of a fill level FS and/or a limit level GS of the substance 2 arranged within a hollow body 18 and/or a density DI and/or a concentration KO of the substance 2.

In addition, the system 19 comprises the measurement radiation source 9 and/or the hollow body 18. The measurement radiation source 9 is designed to emit, in particular emits, the measurement radiation MST to cause the measurement signal MSI. The hollow body 18 is designed to arrange the substance 2 within it.

As the exemplary embodiments shown and explained above make clear, the invention provides an advantageous radiometric measuring apparatus for measuring a measurement variable of a substance, an advantageous system comprising such a radiometric measuring apparatus, and an advantageous method for measuring a measurement variable of a substance by means of such a radiometric measuring apparatus and/or such a system, which has, in particular in each case, improved properties.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A radiometric measuring apparatus for measuring a measurement variable of a substance, the radiometric measuring apparatus comprising:
a photomultiplier having a photocathode, a plurality of dynodes and an anode;
a control device configured to tap off a control signal at a tapping dynode of the dynodes and to control a high voltage applied from the photocathode via the dynodes to the anode as a function of the control signal tapped off; and
a measuring device configured to tap off a measurement signal at the anode with the controlled high voltage applied and to measure the measurement variable as a function of the measurement signal tapped off.

2. The radiometric measuring apparatus according to claim 1,
wherein the control signal is caused by control radiation including cosmic radiation which has not penetrated the substance.

3. The radiometric measuring apparatus according to claim 1,
wherein the measurement signal is caused by measurement radiation emitted by a Co-60, Cs-137, Eu-152, Am-241 and/or Cm-244 measurement radiation source, which has at least partially penetrated the substance.

4. The radiometric measuring apparatus according to claim 1,
wherein the control signal is caused by radiometric, ionizing, control radiation, which has not penetrated the substance,
wherein the measurement signal is caused by radiometric, ionizing, measurement radiation, which has at least partially penetrated the substance, and
wherein the control radiation has higher energy than the measurement radiation.

5. The radiometric measuring apparatus according to claim 1,
wherein the control device is configured to control the high voltage to be so low that the tapped-off control signal in the photomultiplier is linearly amplified, and the tapped-off measurement signal in the photomultiplier is linearly amplified.

6. The radiometric measuring apparatus according to claim 1,
wherein the photomultiplier, from the photocathode via the dynodes to the anode, has a linear gain over a dynamic range having a value of at most 106 radiation events per second and at least 100 radiation events per second.

7. The radiometric measuring apparatus according to claim 1,
wherein the photomultiplier, from the photocathode via the dynodes to the anode, has a linear gain over a dynamic range having a value of at most 105 radiation events per second and at least 101 radiation events per second.

8. The radiometric measuring apparatus according to claim 1,
wherein a linear gain from the tapping dynode to the anode has a value of at least 1.5 and at most 1000.

9. The radiometric measuring apparatus according to claim 1,
wherein a linear gain from the tapping dynode to the anode has a value of at least 3 and at most 100.

10. The radiometric measuring apparatus according to claim 1,
wherein the tapping dynode is close to the anode from one quarter of the dynodes.

11. The radiometric measuring apparatus according to claim 1,
wherein the control device has capacitive control output coupling for tapping off the control signal at the tapping dynode,
wherein the measuring device has capacitive measurement output coupling for tapping off the measurement signal at the anode, and
wherein the measurement output coupling is different from the control output coupling.

12. The radiometric measuring apparatus according to claim 1,
wherein the control device has a control evaluation device which is configured to evaluate the tapped-off control signal for controlling the high voltage, wherein the control evaluation device has a control amplifier which is configured to amplify the tapped-off control signal,
wherein the measuring device has a measurement evaluation device which is configured to evaluate the tapped-off measurement signal for measuring the measurement variable, wherein the measurement evaluation device has a measurement amplifier which is configured to amplify the tapped-off measurement signal, and
wherein the measurement evaluation device is at least partially different from the control evaluation device.

13. The radiometric measuring apparatus according to claim 1, further comprising:
a high-voltage source configured to apply the high voltage.

14. The radiometric measuring apparatus according to claim 1, further comprising:
a scintillator configured to convert radiometric ionizing radiation into photon signals for the photocathode, a rod or solid-state scintillator.

15. The radiometric measuring apparatus according to claim 1,
wherein the measurement variable is representative of a fill level or a limit level of the substance arranged within a hollow body or a density or a concentration of the substance.

16. A system comprising:
a radiometric measuring apparatus according to claim 1; and
a measurement radiation source configured to emit measurement radiation to cause the measurement signal or a hollow body configured to arrange the substance within the hollow body.

17. A method for measuring a measurement variable of a substance by a radiometric measuring apparatus, the method comprising:
a) tapping off a control signal at a tapping dynode and controlling a high voltage applied from a photocathode via dynodes to an anode as a function of the tapped-off control signal by a control device; and
b) tapping off a measurement signal at the anode with the controlled high voltage applied and measuring the measurement variable as a function of the tapped-off measurement signal by a measuring device.
